(19) United States
(12) Patent Application Publication
(10) Pub. No.: US 2017/0225521 A1
(43) Pub. Date: Aug. 10, 2017

(54) LOW PROFILE POSITIVE GRIP RIM LOCK

(71) Applicant: James E. Curry, Glendale, CA (US)

(72) Inventor: James E. Curry, Glendale, CA (US)

(21) Appl. No.: 15/017,633

(22) Filed: Feb. 7, 2016

(51) Int. Cl. B60C 15/02; B60B 25/20; F16B 2/04; B60B 25/10

(52) U.S. Cl. CPC B60C 15/0213; B60B 25/10; B60B 25/20; F16B 2/04; B60B 2900/3312; B60B 2900/523

(57) ABSTRACT

The present invention is a low profile positive grip rim lock for use on off-road vehicle wheel assemblies utilizing standard safety rims, tires, and inner tubes. The rim lock provides a consistent grip with the bead of a tire regardless of the thickness of the bead of the tire, and never contacts the rim. The low profile eliminates the potential of having a pinch flat when the wheel assembly is impacted at the rim lock location.

### FIELD OF THE INVENTION

This invention relates in general to a rim lock for use with a safety rim, inner tube, and tire for vehicles operated at a low tire pressure. The rim lock provides a positive grip to the bead of a tire while remaining isolated from contact with the rim.

### BACKGROUND OF THE INVENTION

A conventional off-road vehicle such as a motorcycle is commonly known to have wheel assemblies having an inner tube associated therewith. Because of the low tire pressures used in off-road motorcycle vehicles, typically between about 6 psi to 16 psi, a device known as a rim lock is provided to prevent the tire from rotating on the rim from the forces of acceleration and braking of the vehicle. It is important that the rim lock provide a strong gripping force on the bead of the tire against the rim to prevent rotation of the tire on the rim. The lower the tire pressure, the more critical the rim lock is to prevent the tire from rotating on the rim. Normally, one rim lock is installed per wheel assembly. Unfortunately, conventional rim locks do not always provide a consistently sufficient gripping force. When the gripping force is insufficient, tube failure occurs where the valve stem of the tube is pulled out due to tire rotation on the rim. Such failure is discussed in U.S. Patent Application Publication US 2010/0300590 A1. Many advanced riders who desire to run pressures below 10 psi install two rim locks so as to double the gripping force to prevent tire rotation. However, running two rim locks is undesirable, as it adds additional weight to the wheel assembly and makes installation of the tire and tube more difficult.

Conventional rim lock designs have inherent drawbacks. In short, they are unnecessarily bulky and are shaped to “bottom out” in the rim when the rim lock nut is tightened. Once the rim lock is “bottomed out,” a set gripping distance between the rim lock and the rim is established. Further tightening of the rim lock nut provides no additional gripping force and simply leads to premature failure of the rim lock. This inherent set gripping distance of conventional rim lock designs is further compounded by the fact that the thickness of the bead of a tire varies substantially between tire manufacturers. Hence, the gripping force established by a given conventional rim lock varies significantly between different tires. Applicant has discovered that the thickness of the bead of the tire varies substantially between different tire manufactures, as much as a 43% variance, and the thinner the bead of the tire the less effective a conventional rim lock is in securing the tire to the rim. Further the bulk of conventional rim locks protrude above the outer edge of the rim when installed, which can cause a pinch flat to the inner tube when the tire is compressed at the rim lock location.

Therefore, what is desirable is to provide a simple, light weight, low profile rim lock that when tightened to a given torque specification, will establish the same gripping force no matter what thickness of the bead of the tire.

### BRIEF SUMMARY OF THE INVENTION

The present invention provides its benefits across a broad spectrum of tire assemblies utilizing inner tubes operated at low tire pressures. While the description which follows hereinafter pertaining to motorcycles is meant to be representative of such applications, it is not exhaustive. It is intended that this specification and the claims appended hereto be accorded a breadth in keeping with the scope and spirit of the invention being disclosed despite what might appear to be limiting language imposed by the requirements of referring to the specific examples disclosed.

It is one aspect of the present invention to provide a rim lock that provides a consistent grip with the bead of a tire regardless of the variance in the thickness of the beads from different tire manufacturers.

It is another aspect of the present invention to provide a rim lock that has a low profile inside the wheel assembly.

It is a feature of the present invention that the rim lock body is made from straight tubular material.

It is another feature of the present invention that curved gripping teeth are formed which embed themselves into the tire bead on installation.

It is yet another feature of the present invention that circular cavities are provided to establish the curved gripping teeth that protrude at their greatest amount at the grip edges of the body of the rim lock.

It is still another feature of the present invention that the outside radius of the rim lock body is sized for a specific size safety rim so that, when installed, never makes contact with the rim.

It is an advantage of the present invention that for a given torque setting, a consistent gripping force is established between the rim lock and the bead of the tire.

It is another advantage of the present invention that the rim lock effectively eliminates pinch flats of the inner tube when the tire is compressed at the rim lock location on the wheel.

These and other aspects, features, and advantages are achieved/attained in the apparatus of the present invention that comprises a rim lock for an off-road tire mounted on a safety rim with a inner tube installed in between the tire and the rim. The rim lock has a straight tubular body having a threaded stud, opposed edges, grip edges, and a uniform thickness between a top surface and a bottom surface. A plurality of circular cavities are provided which form a plurality of curved gripping teeth. The circular cavities are established at an offset distance and teeth angle such that the curved gripping teeth protrude at their greatest amount from the circular cavities were they meet the grip edges. Preferably the opposed edges and grip edges are rounded flush with the bottom surface of the body, and the grip edges are rounded flush with the top surface of the body. For a particular rim size “t”, the outside radius “o.r.” of the curved top surface should be: 1.4≦“t”/“o.r.”≦2.6, and preferably between 1.6≦“t”/“o.r.”≦1.9. In addition, the width of the rim lock “w” should be between equal to the rim size “t” and “t” minus 0.15 inches (“t”≧“w”≧“t”−0.15 inches).

### BRIEF DESCRIPTION OF THE DRAWINGS

The aspects, features and advantages of the present invention will become apparent upon consideration of the following detailed disclosure of the invention, especially when it is taken in conjunction with the accompanying drawings wherein:

FIG. 1 is a top view of a conventional motorcycle rim lock.

FIG. 2 is a front view of the conventional motorcycle rim lock of FIG. 1.

FIG. 3 is a side view of the conventional motorcycle rim lock of FIG. 1.

FIG. 4 is across-sectional view of FIG. 1.

FIG. 5 is a cross-sectional view of a safety rim and thin bead tire with the conventional motorcycle rim lock of FIG. 1 prior to being tightened.

FIG. 6 is a cross-sectional view of a safety rim and thin bead tire with the conventional motorcycle rim lock of FIG. 1 after being tightened.

FIG. 7 is a cross-sectional view of a safety rim and thick bead tire with the conventional motorcycle rim lock of FIG. 1 prior to being tightened.

FIG. 8 is a cross-sectional view of a safety rim and thick bead tire with the conventional motorcycle rim lock of FIG. 1 after being tightened.

FIG. 9 is an isometric view of the present invention rim lock.

FIG. 10 is atop view of the present invention rim lock of FIG. 9.

FIG. 11 is a front view of the present invention rim lock of FIG. 9.

FIG. 12 is a side view of the present invention rim lock of FIG. 9.

FIG. 13 is an angled side view of the present invention rim lock taken in the direction shown in FIG. 12.

FIG. 14 is a cross-sectional view of FIG. 10 of the present invention rim lock of FIG. 9.

FIG. 15 is a cross-sectional view of a safety rim and thin bead tire with the present invention rim lock of FIG. 9 prior to being tightened.

FIG. 16 is a cross-sectional view of a safety rim and thin bead tire with the present invention rim lock of FIG. 9 after being tightened.

FIG. 17 is a cross-sectional view of a safety rim and thick bead tire with the present invention rim lock of FIG. 9 prior to being tightened.

FIG. 18 is a cross-sectional view of a safety rim and thick bead tire with the present invention rim lock of FIG. 9 after being tightened.

To facilitate understanding, identical reference numerals have been used, where possible, to designate identical elements or features common to the figures.

### BACKGROUND ART

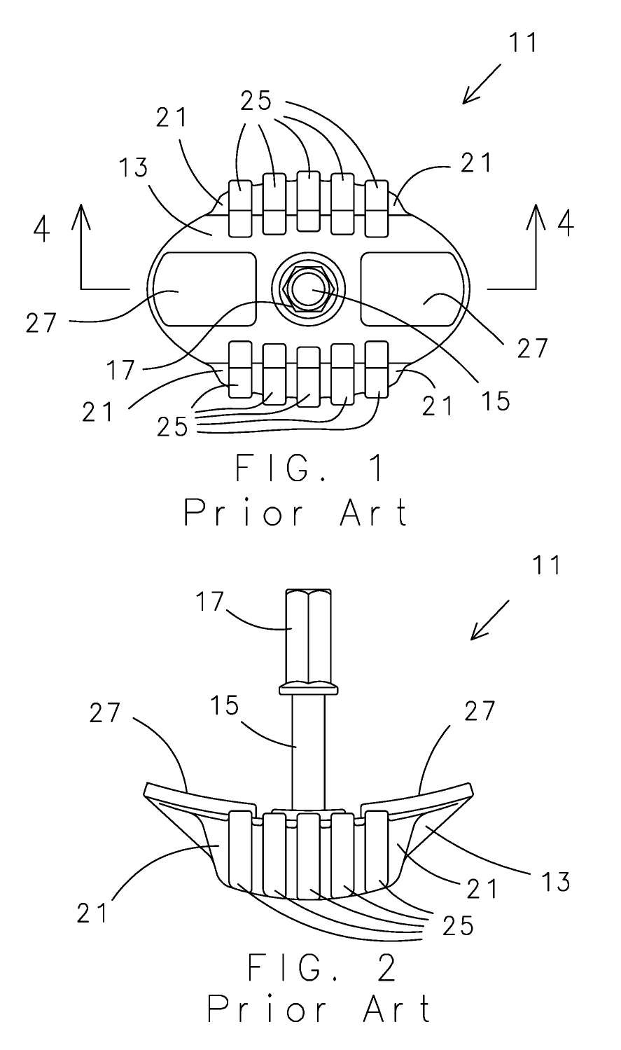

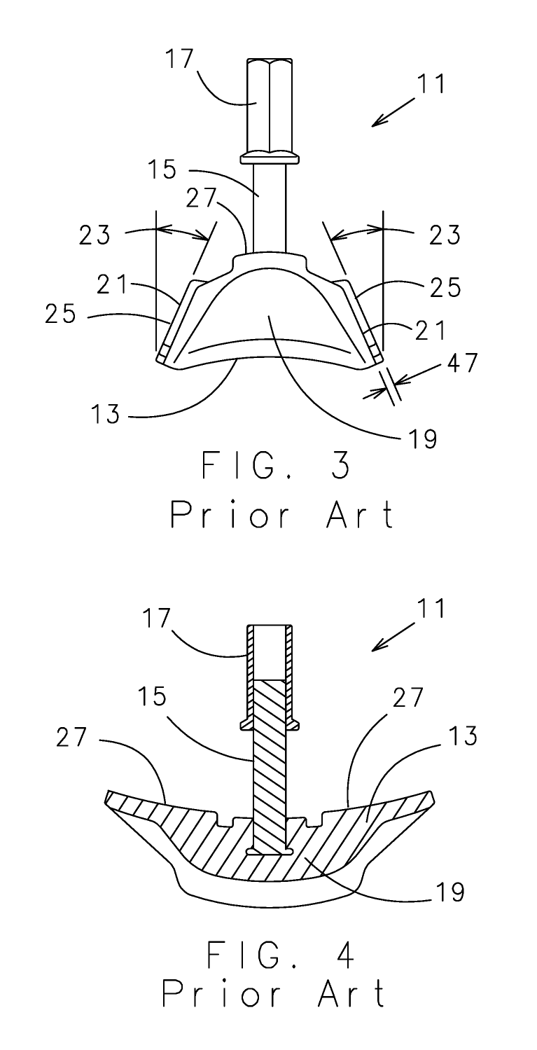

Off-road motorcycle rim locks have been around for decades. They generally follow a conventional design and are most commonly encapsulated in rubber, or an equivalent elastomeric material. Referring to FIGS. 1-8, a prior art rim lock is shown generally by numeral 11 to illustrate its conventional design and its inherent drawbacks. The rim lock 11 comprises a body 13, threaded stud 15, and nut 17. Referring to FIG. 4, the stud 15 is encapsulated in the body 13 and establishes a bulky central body portion 19. The body 13 has two significant conventional features. The first is two flat gripping surfaces 21 positioned at a slant angle 23 shown in FIG. 3. Each gripping surface 21 is provided with a plurality of protruding linear ledges 25. The second conventional feature is a curved bottoming ridge 27 specifically shaped and sized to make uniform contact with the rim during installation. Typically the body portion is encapsulated with a layer of rubber, including gripping surfaces 21 and protruding ledges 25, which protrude only about a 1/16″ from the gripping surfaces 21, as illustrated by numeral 47 in FIG. 3.

For years riders have encountered rim lock failures. Typically the encapsulation of rubber over the gripping surfaces 21 are torn off or smashed flat, and often the stud 15 has been partially torn out of the central body portion 19 of the rim lock 11. When either or both of these occur, the rim lock 11 can no longer keep the tire from rotating on the rim, causing inner tube failure, resulting in a flat tire. Applicant has determined the cause of this problem.

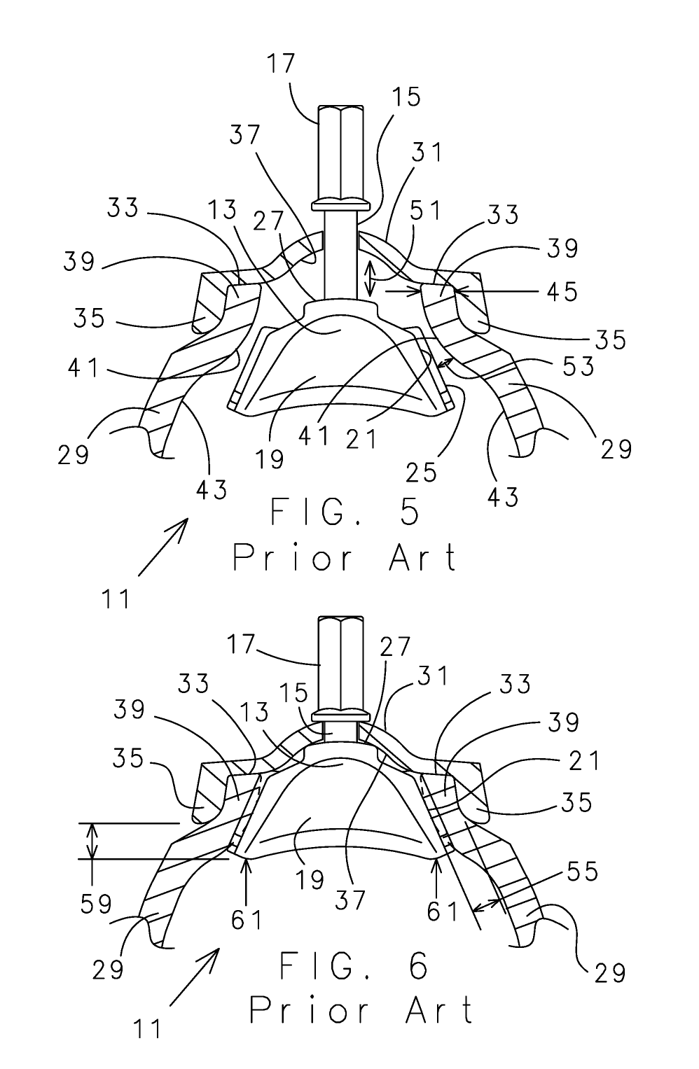

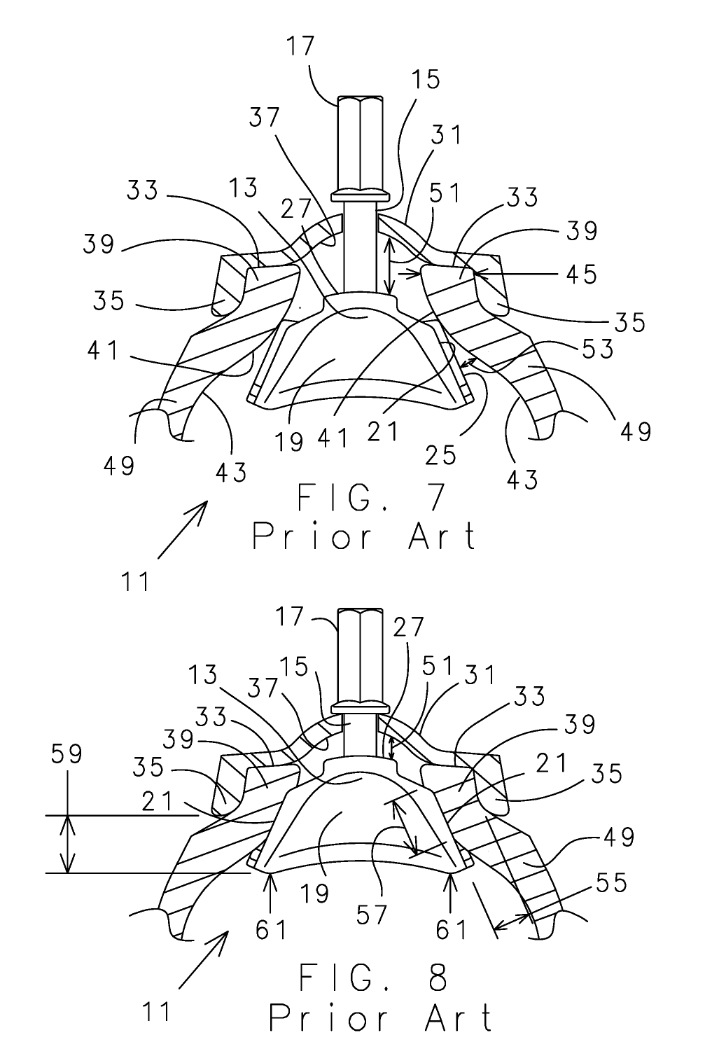

Referring to FIGS. 5-8, the drawbacks of the conventional rim lock 11 that result in rim lock failure are explained. The safety rim 31 has a generally flat shelf 33 located between two upturned vertical lips 35 in between a downturned arcuate beadwell 37. The tire has two beads 39 that fit into the rim 31 up against flat shelves 33 and vertical lips 35. Referring to FIGS. 5 and 7, each bead has an outward curved surface 41 that blends into the inside surface 43 of the tire, and has an initial bead thickness 45. Applicant has discovered there appears to be no standard bead thickness followed by the plurality of different tire manufacturers, and that the variance in thickness is significant. Applicant measured the initial bead thickness 45 between two tires designed to be mounted on the same 18 inch rear rim from two different tire manufactures. One bead thickness was 0.464 inches and the other was 0.264 inches. The difference in thickness, essentially 0.2 inches, is a 43% variance between these manufacturers. FIGS. 5-6 show a cross section of a thin bead tire 29, a safety rim 31, and side view of the conventional rim lock 11. The thin bead tire 29 represents the tire bead that was measured at 0.264 inches. FIGS. 7-8 show a cross section of a thick bead tire 49, safety rim 31, and side view of the conventional rim lock 11. The thick bead tire 49 represents the tire bead that was measured at 0.464 inches.

In FIG. 5, the rim lock 11 is shown in its loose condition with the nut 17 un-tightened with the thin bead tire 29. As can be seen in FIG. 5, there is a gap, illustrated by numeral 51, between the curved bottom ridge 27 of the rim lock 11 and the arcuate beadwell 37 of the rim 31; and a gap, illustrated by numeral 53, between the linear ledges 25 of the rim lock 11 and the outward curved surfaces 41 of the beads 39. These gaps, 51 and 53, are intended to disappear when the rim lock nut 17 is properly tightened.

Referring to FIG. 6, the conventional rim lock 11 is shown in its tightened condition with the thin bead tire 29. When tightened, the curved bottom ridge 27 makes contact with the arcuate beadwell 37, and when the rim lock nut 17 is tightened to its final torque (between about 10-13 ft-lbs), the curved bottom ridge 27 of the rim lock 11 is “bottomed out” in the arcuate beadwell 37. At this point a “set gripping distance” 55 is established between the flat gripping surfaces 21 of the rim lock 11 and the upturned vertical lips 35 of the rim 31. Further tightening of the rim lock nut 17 at this point does not effectively provide any additional gripping force by the rim lock 11, but instead induces excessive stress to the stud 15 that is encapsulated in the central body portion 19 of the rim lock 11. This excessive stress can undesirably cause the stud 15 to be pulled out from the central body portion 19, causing rim lock failure. This problem is further compounded when the rubber encapsulation on the protruding linear ledges 25 are torn or flattened, which substantially reduces the gripping force of the rim lock 11, which leads to tire slippage and inner tube failure.

In FIG. 7, the rim lock 11 is shown in its loose condition with the nut 17 un-tightened with the thick bead tire 49. Again, there is gap 51 between the curved bottom ridge 27 of the rim lock 11 and the arcuate beadwell 37 of the rim 31; and gap 53 between the linear ledges 25 of the rim lock 11 and the outward curved surfaces 41 of the beads 39. Although these gaps, 51 and 53, are intended to disappear when the rim lock nut 17 is properly tightened, they do not when tightened with the thick bead tire 49.

Referring to FIG. 8, the rim lock 11 is shown in its tightened condition with the thick bead tire 49. Because of the thickness of the bead, gap 51 does not disappear, and a smaller portion of the flat gripping surfaces 21 and protruding linear ledges 25 engage the tire bead, illustrated by numeral 57. When the rubber encapsulation on the protruding linear ledges 25 are torn or flattened, which often occurs in the area identified by numeral 57, the rim lock 11 does not provide sufficient gripping force to prevent the tire 49 from slipping on the rim 31. This slipping typically occurs when the nut 17 is not sufficiently tightened, and once it occurs the rubber encapsulation on the protruding linear ledges 25 and torn and flattened. Over time the rim lock 11 loses its ability to properly grip the bead of the tire 49 without additional tightening of the nut 17, which in turn can undesirably cause the stud 15 to be pulled out from the central body portion 19.

Where the conventional rim lock 11 is shown properly tightened on the rim 31 in FIGS. 6 and 8, there is a protrusion distance, illustrated by numeral 59, where the rim lock 11 extends outward from the edge of the upturned vertical lips 35 of the rim 31. This protrusion distance 59 undesirably establishes a location on the rim lock, illustrated by numeral 61, that can easily pinch the inner tube when the tire and inner tube are “sandwiched” at the rim lock location of the wheel assembly from impact with an obstacle. Hence, this protrusion distance 59 established by conventional rim locks 11 creates location 61 that unnecessarily can lead to a flat tire.

Applicant has discovered is that the large bead variance between the tire manufacturers makes the conventional rim lock design inadequate in providing a consistent and proper gripping force for tires in this variance range. This explains the rim lock failures that have been occurring for years. A rider installs the rim lock with a tire having a thin bead, notices the inner tube valve stem being pulled sideways in the rim resulting from some tire slippage, then over tightens the rim lock nut to the point that the stud starts to pull out of the central body portion of the rim lock, resulting in rim lock and tire failure. The rider inspects the failed rim lock, noting the rubber torn off the gripping surfaces and that the stud is pulling out of the body portion. He then purchases another rim lock and overtime repeats the same failure.

### DISCLOSURE OF THE INVENTION

It is to be appreciated that Applicant has abandoned the conventional wisdom in the prior art. First, Applicant's rim lock is of a straight tubular design and does not conform to the rim as the curved bottom ridge 27 of the prior art. Second, Applicant's rim lock is designed so that it never makes contact with the rim. Third, the gripping teeth of applicants rim lock are formed in a curved top surface so that they will always positively engage thin or thick bead tires. Forth, the low profile of the tubular design eliminates the establishment of location 61 of the prior art rim that can pinch the inner tube. And fifth, Applicant has abandoned the conventional wisdom of encapsulating the body with rubber or equivalent elastomeric material. Further novel features will be understood herein.

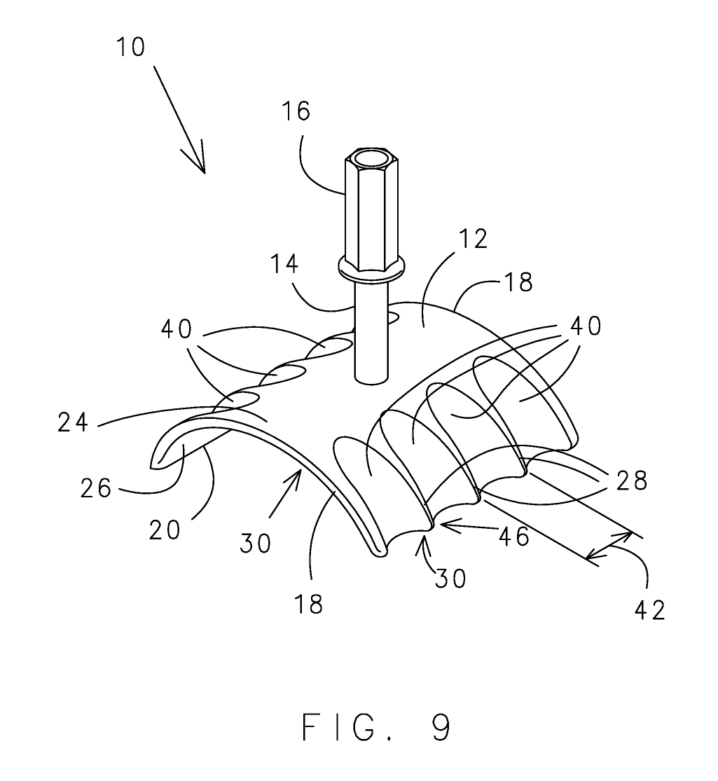

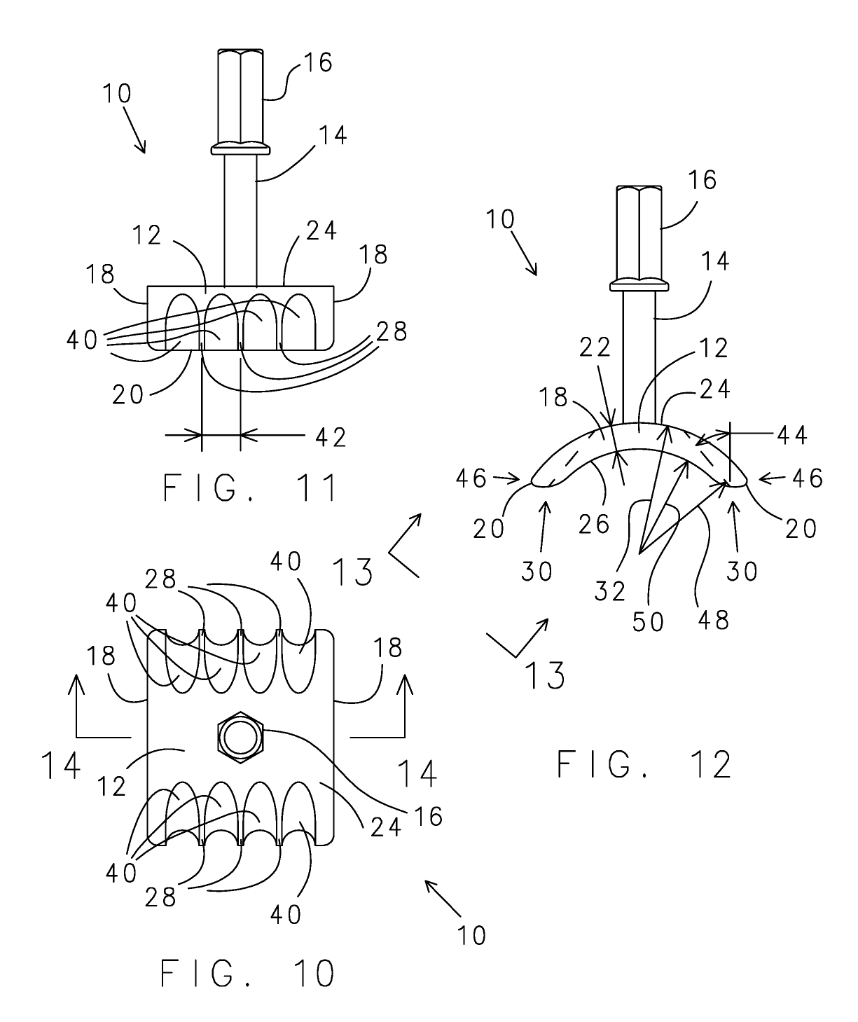

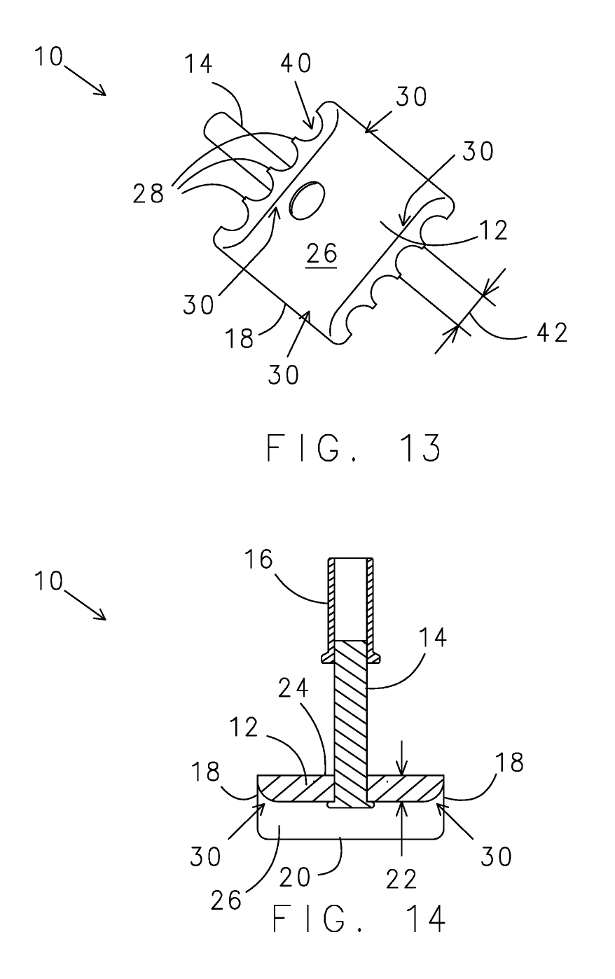

Referring now to FIGS. 9-18, an embodiment of the present invention low profile positive grip rim lock 10 is shown. The rim lock 10 comprises a straight tubular body 12, threaded stud 14, and rim lock nut 16. The tubular body 12 has opposed edges 18, grip edges 20, and a uniform thickness 22 between a top surface 24 and bottom surface 26. The threaded stud 14 is integrally secured to the body by any conventional means such as, for example, as a threaded fastener or press fit lug. The opposed edges 18 and grip edges 20 are rounded flush in a radius approximate the thickness 22 of the body 12 inward where they become flush with the bottom surface 26 of the body 12, shown by numeral 30 in FIGS. 9, 12, 13, and 14. This is done to provide a smooth surface where the inner tube will be in contact with the rim lock once it is installed and the tube is inflated. The grip edges 20 are also rounded flush with the curved top surface 24, shown by numeral 46 in FIGS. 9 and 12. This is done to prevent the rim lock 12 from cutting into the bead of the tire during installation and un-installation. A plurality of gripping teeth 28 are provided on the top surface of the tubular body 12 adjacent the grip edges 20. As shown in FIGS. 9, 10, and 11, a plurality of circular cavities 40 are provided which form the curved gripping teeth 28. The circular cavities 40 are established at an offset distance 48 and teeth angle 44 as shown in FIG. 12. Preferably the teeth angles 44 should be between 40 and 50 degrees. The offset distance 48 is greater than the inside radius 50 of the bottom surface 26, and preferably greater than the inside radius 50 by an amount at least ¼ the thickness 22 of the tubular body 12. The gripping teeth 28 protrude at their greatest amount from the circular cavities 48 where they meet the grip edges 20, and taper away into the top surface 24 of the body, as seen in FIG. 9. Referring to FIG. 13, the distance between each gripping teeth, shown by numeral 42, is at least as great as the thickness 22 of the tubular body, and preferably about between about 1.25 to 2.0 the thickness 22 of the tubular body.

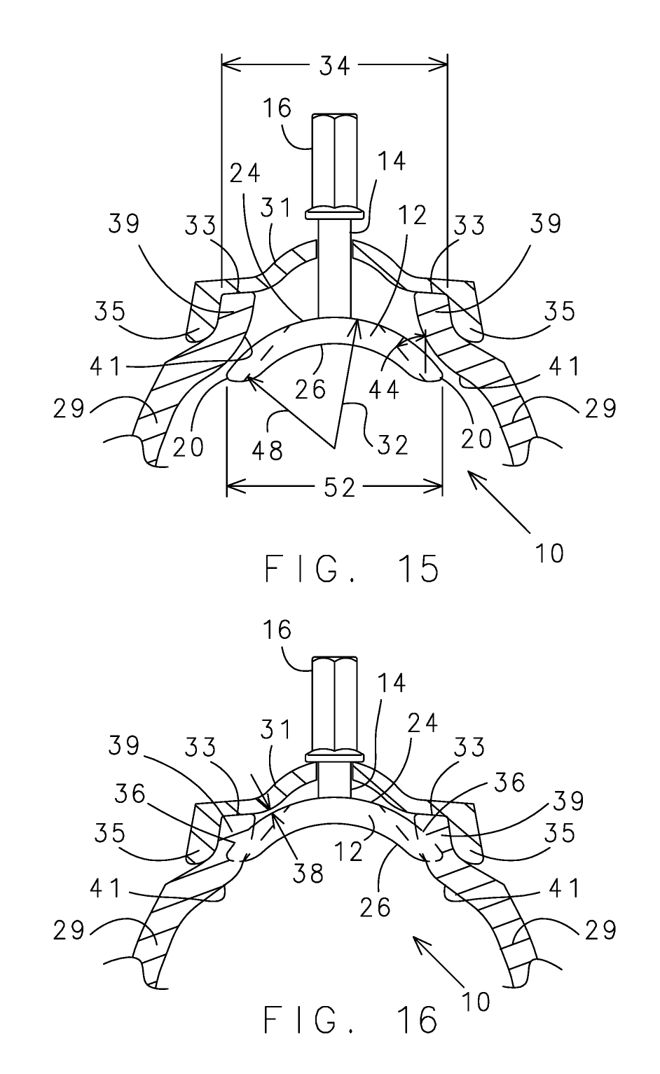

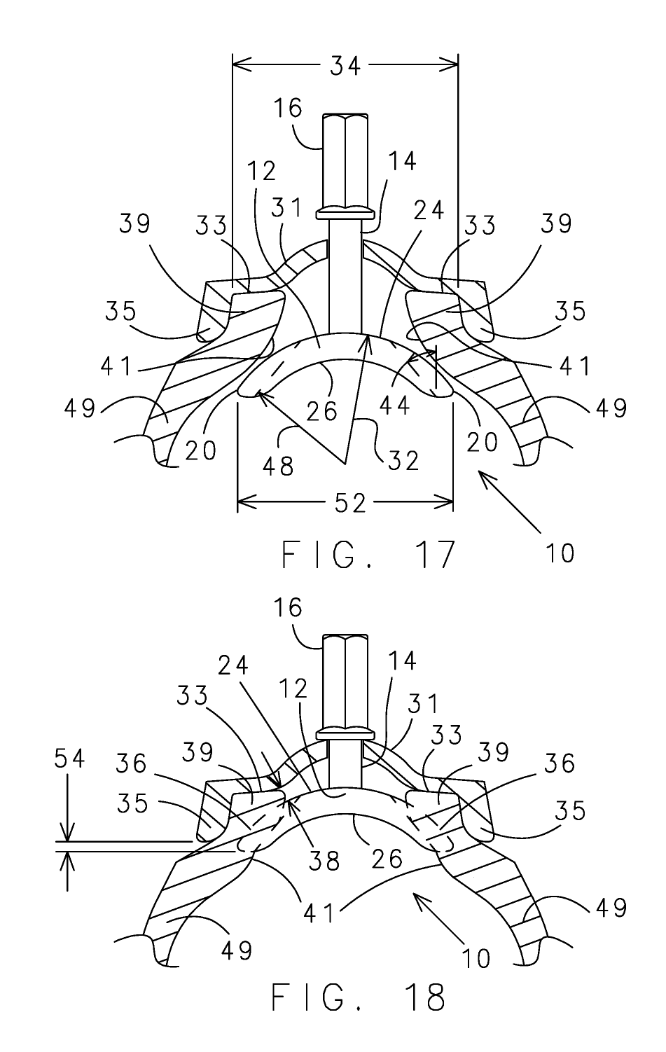

The tubular body 12 has an outside radius 32 which must be selected for a specific safety rim size in order for the rim lock 10 to provide the same gripping force throughout the thickness variance found among the tire manufactures, while keeping the rim lock from ever touching or bottoming in the rim. Referring to FIGS. 15 and 17, the rim size, shown by numeral 34, is the distance between the intersection of the flat shelf 33 and the upturned vertical lips 35 of the safety rim 31. This measurement, herein “t”, is consistent among the rim manufactures for a specific rim size. Applicant has determined that the ratio between “t”, and the outside radius 32 of the curved top surface 24 of the body 12, herein “o.r.”, should be as follows for any particular safety rim size: 1.4≦“t”/“o.r.”≦2.6, and preferably between 1.6≦“t”/“o.r.”≦1.9. In addition, the width of the rim lock 10, herein “w”, measured as the distance between the grip edges 20, shown by numeral 52, should be between equal to the rim size “t” and “t” minus 0.15 inches (“t”≧“w”≧“t”−0.15 inches).

The reason for selecting the proper “o.r.” is discussed in conjunction with FIGS. 15-18. FIG. 15 shows the present invention rim lock 10 prior to being tightened on a rim with the same thin bead tire shown in FIG. 5; and FIG. 17 shows the rim lock 10 prior to being tightened on a rim with the same thick bead tire shown in FIG. 7. Significantly, the outward curved surface 41 of the beads 39 of the tire 29 slope outwardly and away from the outside radius 32 of the rim lock 10. In this geometric layout, the gripping teeth 28 will always make positive contact with the beads 39 regardless of the thickness of the bead of the tire, and will embed themselves into the beads 39 of the tire 29 when the rim lock 10 is tightened. This is a significant advantage over the flat gripping surface 21 of the prior art, that has a set gripping distance 55 shown in FIGS. 6 and 8. Because of the curved outside radius 32 of the present invention rim lock 10, there is no set gripping distance 55, and since the rim lock 10 never contacts the rim, all torque applied to the nut 16 translates to a direct gripping force of the gripping teeth 28 against the bead of the tire. In FIG. 16, the rim lock 10 is shown after the rim lock nut 16 has been properly tightened with the same thin bead tire shown in FIG. 6; and FIG. 18 shows the rim lock 10 properly tightened with the same thick bead tire shown in FIG. 8. In both FIGS. 16 and 18, dash lines 36 represent the penetration of the gripping teeth 28 as they embed themselves into the bead of the tire. Significantly, the gripping teeth 28 embed themselves where they protrude at their greatest amount from the circular cavities 48 at the grip edges 20, providing a consistent grip to the bead of the tire regardless of the thickness of the bead. An air gap, shown generally by numeral 38, shows that the rim lock 10 never makes contact with the rim 31. Significantly, all the torque applied to the rim lock nut is directly transferred to the gripping teeth 28 embedded in the bead of the tire. Hence, the same torque applied to the rim lock nut results in the same gripping force between the rim lock and the tire, no matter what variance in the bead thickness of the tire. This is achieved by selecting the “o.r.” in accordance with the ratio above, for a particular safety rim size “t”. In addition, the air gap 38 assures that the rim lock nut, even when over tightened, will not cause failure of the threaded stud 14 of the rim lock, since all tightening simply applies greater gripping force into the rubber bead of the tire.

The reason for selecting the width of the rim lock to be between equal to the rim size “t” and “t” minus 0.15 inches (“t”≧“w”≧“t”−0.15 inches) is to assure that the gripping teeth 28 at the grip edges 20 will positively engage the tire bead of any thickness variance. Upon properly tightening the rim lock nut 16, the gripping teeth 28 are embedded into the tire bead such that the circular cavities 40 make contact with the tire bead at the grip edges 20. This assures a positive grip for the rim lock 10 regardless of the variance in the thickness of tire beads.

FIGS. 16 and 18 also illustrate the low profile nature of the present invention rim lock 10. In FIG. 16 where the rim lock 10 is installed with the thin bead tire, the rim lock 10 remains below the rim and there is no protrusion distance 59 as there is with the prior art rim lock 11 shown in FIG. 6. In FIG. 18 where the rim lock 10 is installed with the thick bead tire, there is only a slight protrusion distance, shown by numeral 54, which is significantly smaller than the protrusion distance 59 with the prior art rim lock 11 shown in FIG. 8. Compared to the prior art rim lock 11, the low profile nature of the present invention rim lock 10 effectively eliminates inner tube pinch flats on impacts that “sandwich” the tire at the rim lock location.

In a preferred embodiment, the body is made from aluminum pipe material and the gripping teeth 28 are established by machining circular cavities 40 in the top surface 24 of the tubular body 12. Alternatively, the body 12 could be made from other lightweight metals and alloys, such as, for example titanium, and the body could be formed by casting or forging instead of machining.

One embodiment for a 2.15 inch size rim (“t”), the rim lock is formed from aluminum pipe material having an outside diameter of 2.5 inches (“o.r.”=1.25), a thickness of 0.25 inches, a offset distance of 1.765 inches, a teeth angle of 45 degrees, a width (“w”) of 2.01 inches, four circular cavities on each side machined at a diameter of 0.375 inches, a distance between each gripping teeth of 0.390 inches, and a overall straight pipe length of 1.75 inches. For this rim lock, “t”/“o.r.” is 1.72, the width (“w”) is 0.14 inches smaller than the rim size (“t”), and the distance between each gripping teeth is 1.56 times the thickness of the pipe material (0.390/0.25). The 2.15 inch size rim is common for rear motorcycle rims having either an 18 inch or 19 inch diameter. In another embodiment for a 1.60 inch size rim (“t”), the rim lock is formed from aluminum pipe material having an outside diameter of 1.75 inches (“os.”=0.875), a thickness of 0.25 inches, a offset distance of 0.783 inches, a teeth angle of 45 degrees, a width (“w”) of 1.470 inches, three circular cavities on each side machined at a diameter of 0.375 inches, a distance between each gripping teeth of 0.365 inches, and a overall straight pipe length of 1.47 inches. For this rim lock, “t”/“o.r.” is 1.83, the width “w” is 0.13 inches smaller than the rim size (“t”), and the distance between each gripping teeth is 1.46 times the thickness of the pipe material (0.365/0.25). The 1.60 inch size rim is common for front motorcycle rims having a 21 inch diameter.

What has been described are preferred embodiments of a low profile positive grip rim lock for off-road tire assemblies. Those skilled in the art will appreciate that numerous modifications are possible without materially departing from the novel teachings and advantages of the subject matter described herein. Other modifications, substitutions, changes, and omissions may be made in the design and arrangement of the preferred and other exemplary embodiments without departing from the spirit of the present invention.

What is claimed is:

1. A rim lock for use with a safety rim, comprising:
a tubular body having a curved top surface, a bottom surface, opposed edges, grip edges, a plurality of curved gripping teeth, and a threaded stud; the plurality of curved gripping teeth formed in the curved top surface adjacent the grip edges.

2. The rim lock of claim 1, wherein:
the safety rim has a size “t”, the curved top surface having a radius “o.r.”, and the ratio “t”/“o.r.” is between 1.4 and 2.6.

3. The rim lock of claim 2, the grip edges are separated by a distance “w”, the distance “w” being between equal to “t” and “t”−0.15 inches.

4. The rim lock of claim 2, wherein the opposed edges and the grip edges are rounded flush with the bottom surface of the body.

5. The rim lock of claim 2, wherein the grip edges are rounded flush with the curved top surface of the body.

6. The rim lock of claim 2, wherein the tubular body has a thickness and the distance between each gripping teeth is at least as great as the thickness of the tubular body.

7. The rim lock of claim 6, wherein the distance between each gripping teeth is about between about 1.25 to 2.0 the thickness of the tubular body.

8. The rim lock of claim 2, wherein the curved gripping teeth formed in the curved top surface adjacent the grip edges by a plurality of circular cavities formed at an offset distance and teeth angle, the bottom surface having a inside radius and the offset distance being greater than the inside radius.

9. The rim lock of claim 8, wherein the teeth angle is between 40 and 50 degrees.

10. The rim lock of claim 8, wherein the tubular body has a uniform thickness and the offset distance is greater than the inside radius by at least ¼ the uniform thickness of the tubular body.

11. A rim lock for use with a safety rim having a size “t”, comprising:
a tubular body having a curved top surface, a bottom surface, opposed edges, grip edges, a plurality of curved gripping teeth, and a threaded stud; and
the plurality of curved gripping teeth formed in the curved top surface adjacent the grip edges adjacent a plurality of circular cavities in-between each gripping teeth, each circular cavity formed at an offset distance and teeth angle, the bottom surface having an inside radius and the offset distance being greater than the inside radius; and
the curved top surface having a outside radius “o.r.”, and the ratio “t”/“o.r.” is between 1.4 and 2.6.

12. The rim lock of claim 11, wherein the tubular body has a uniform thickness and the offset distance is greater than the inside radius by at least ¼ the uniform thickness of the tubular body.

13. The rim lock of claim 11, the grip edges separated by a distance “w”, the distance “w” being between equal to “t” and “t”−0.15 inches.

14. The rim lock of claim 11, wherein the teeth angle is between 40 and 50 degrees.

15. The rim lock of claim 11, wherein the opposed edges and the grip edges are rounded flush with the bottom surface of the body.

16. The rim lock of claim 11, wherein the grip edges are rounded flush with the curved top surface of the body.

17. The rim lock of claim 11, wherein the tubular body is formed from straight pipe material.
